(19) United States
(12) Patent Application Publication
(10) Pub. No.: US 2010/0019155 A1
(43) Pub. Date: Jan. 28, 2010

(54) LUMINESCENCE SENSORS USING SUB-WAVELENGTH APERTURES OR SLITS

(75) Inventors: Derk Jan Wilfred Klunder, Eindhoven (NL); Maarten Marinus Johannes Wilhelm Van Herpen, Eindhoven (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,947

(22) PCT Filed: Jun. 16, 2006
(86) PCT No.: PCT/IB2006/051942

§ 371 Date: Dec. 18, 2007

(30) Foreign Application Priority Data
Jun. 23, 2005 (EP) 05105599.4

(51) Int. Cl. G01N 21/64; G01N 21/63

(52) U.S. Cl. 250/363.01

(57) ABSTRACT

The present invention provide a qualitative or quantitative luminescence sensor, for example a bio sensor or chemical sensor, using sub-wavelength aperture or slit structures, i.e. using apertures or slit structures having a smallest dimension smaller than the wavelength of the excitation radiation in the medium that fills the aperture or slit structure. The invention furthermore provides a method for the detection of luminescence radiation generated by one or more luminophores present in aperture or slit structure in such a luminescence sensor.

The present invention relates to qualitative or quantitative luminescence sensors, for example biosensors, and more particularly to luminescence sensors using sub-wavelength aperture or slit structures. The invention furthermore relates to a method for the detection of luminescence radiation generated by one or more luminophores present in aperture or slit structure in such a luminescence sensor.

Sensors are widely used for measuring a physical attribute or a physical event. They output a functional reading of that measurement as an electrical, optical or digital signal. That signal is data that can be transformed by other devices into information. A particular example of a sensor is a biosensor. Biosensors are devices that detect the presence of (i.e. qualitative) or measure a certain amount (i.e. quantitative) of target molecules such as e.g., but not limited thereto, proteins, viruses, bacteria, cell components, cell membranes, spores, DNA, RNA, etc. in a fluid, such as for example blood, serum, plasma, saliva, . . . . The target molecules also are called the “analyte”. In almost all cases, a biosensor uses a surface that comprises specific recognition elements for capturing the analyte. Therefore, the surface of the sensor may be modified by attaching specific molecules to it, which are suitable to bind the target molecules which are present in the fluid.

For optimal binding efficiency of the analyte to the specific molecules, large surface areas and short diffusion lengths are highly favorable. Therefore, micro- or nano-porous substrates (membranes) have been proposed as biosensor substrates that combine a large area with rapid binding kinetics. Especially, when the analyte concentration is low (e.g. below 1 nM, or below 1 pM) the diffusion kinetics play an important role in the total performance of a biosensor assay.

The amount of bound analyte may be detected by fluorescence. In this case the analyte itself may carry a fluorescent label, or alternatively an additional incubation with a fluorescently labelled second recognition element may be performed.

Detecting the amount of bound analyte can be hampered by several factors, such as scattering, bleaching of the luminophore, background fluorescence of the substrate and incomplete removal of excitation light. Moreover, to be able to distinguish between bound labels and labels in solution it is necessary to perform a washing step (or steps) to remove unbound labels.

US 2003/0174992 A1 relates to zero-mode waveguides and their use to confine effective observation volumes that are smaller than the normal diffraction limit. The zero-mode waveguides comprise a cladding partially or fully surrounding a core, where the core is configured to preclude propagation of electromagnetic energy of a frequency less than a cut-off frequency longitudinally through the zero-mode waveguides. An illumination source directs excitation radiation to target material present in the zero-mode waveguides. Emitted radiation is then passed to a detector which identifies the type of emission and which is positioned at a same side of the zero-mode waveguides as the illumination source.

There is a problem in separating the excitation and luminescence radiation, e.g. fluorescence radiation, because these types of radiation have a similar wavelength. Furthermore, part of the emitted radiation may be lost because it may pass through the zero-mode waveguide and thus is directed to the other side of the waveguide than the side where the detector is positioned.

It is an object of the present invention is to provide improved qualitative or quantitative luminescence sensors, for example biosensors, and more particularly to improved luminescence sensors using sub-wavelength aperture or slit structures and to provide a method for the detection of luminescence radiation generated by one or more luminophores present in aperture or slit structure in such a luminescence sensor.

An advantage of the present invention is provision of a luminescence sensor, such as e.g. a biosensor or a chemical sensor, with a good signal-to-background ratio. A further advantage of the present invention is the ability to separate excitation and luminescence radiation, e.g. fluorescence radiation.

The above objective is accomplished by a method and device according to the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

In a first aspect of the present invention, a luminescence sensor system is provided. The luminescence sensor system comprises a luminescence sensor, an excitation radiation source and a detector. The luminescence sensor comprises a substrate provided with at least one aperture or slit having a smallest dimension and with at least one luminophore in the at least one aperture for being excited by excitation radiation having a wavelength. The at least one aperture or slit is for being filled with a medium. The medium may be a liquid or a gas, but may also be vacuum comprising at least one luminescent particle to be detected. In use the sensor may be immersed in the medium, e.g. in a liquid medium, or the at least one aperture or slit may be filled with the medium in any other suitable way, e.g. by means of a micropipette in case of a liquid medium, or e.g. by spraying a gas over the sensor and into the at least one aperture or slit. The smallest dimension of the at least one aperture or slit is smaller than the wavelength of the excitation radiation in the medium that fills the at least one aperture. The luminescence sensor has a first and a second side being opposite to each other. According to the present invention, the excitation radiation source is located at the first side of the luminescence sensor, and the detector is located at the second side.

The luminescence sensor according to the invention has the ability to separate excitation and luminescence radiation. Furthermore, the luminescence sensor shows a better splitting of the measurement signal and background signal with respect to the prior art sensors. Therefore, the rinsing step in the detection process, as known from using prior art sensors, can be omitted.

According to embodiments of the invention, the apertures may have a square, circular, elliptical, rectangular, polygonal, . . . shape. Moreover, an aperture can have more than one dimension, typically an aperture may have two or three dimensions. Therefore, according to embodiments of the invention, when the dimension of an aperture is mentioned, the smallest dimension is to be considered.

According to an embodiment of the invention, the smallest dimension of the at least one aperture or slit may be below the diffraction limit of the medium with which the at least one aperture is filled. ‘The medium with which the at least one aperture is filled’ is an immersion fluid, which may be a liquid or a gas in which the sensor is immersed. The smallest dimension of the at least one aperture or slit may be smaller than 50% of the wavelength of the excitation radiation in the medium with which the at least one aperture or slit is filled, preferably smaller than 40% of the wavelength of the excitation radiation in the medium with which the at least one aperture or slit is filled.

In a particular embodiment of the invention, the immersion fluid may be water. In that case, the smallest dimension of the at least one aperture or slit may be lower than the diffraction limit of water at the excitation wavelength. The diffraction limit is a function of both the excitation wavelength or frequency and the refractive index of the surrounding medium.

In embodiments according to the invention, the substrate may comprise at least one hole. In particular embodiments, the at least one hole may have slanted sidewalls.

In other embodiments the substrate may comprise at least one slit.

In embodiments according to the invention, the substrate may comprise an array of apertures or slits. The array may be a periodic array of apertures or slits, i.e. the apertures or slits may be positioned at equal distances from each other, in one or two dimensions.

In an embodiment according to the invention, the substrate provided with at least one aperture or slit may be positioned on top of another substrate. The other substrate may support the substrate that is provided with the at least one aperture or slit. This may lead to an improved mechanical strength. The other substrate may be transparent for excitation radiation and/or luminescent radiation.

In embodiments according to the invention, the substrate provided with at least one aperture or slit may be positioned between a first or upper slab and a second or lower slab. The first or upper slab and the second or lower slab may, according to some embodiments, be patterned.

According to embodiments of the invention, the radiation detector may e.g. be a CCD or CMOS detector.

In embodiments according to the invention, the luminescence sensor may for example be a luminescence biosensor or a luminescence chemical sensor.

In embodiments according to the invention, the apertures may be configured in such a way that the luminescence radiation is sent toward the detector with the luminescence signal concentrated in a smaller spatial angle. This may, for example, be the case when the apertures have a triangular shape.

The at least one aperture or slit may comprise inner surface walls. According to embodiments of the invention, the inner surface walls of the at least one aperture or slit may comprise surface immobilized ligands that can recognize one or more targets of interest, also called the analyte. This improves the selectivity of the sensor, for example biosensor or chemical sensor. In the case where more than one analyte has to be detected, the sensor may comprise an array of different ligands. Examples of suitable ligands may be proteins, antibodies, aptamers, peptides, oligonucleotides, sugars, lectins, etc. The ligands may be immobilized to the inner surface walls of the at least one aperture or slit e.g. via suitable surface chemistry. The choice of surface chemistry merely depends on the chemical composition of the inner surface walls.

In a second aspect of the invention, a method is provided for the detection of luminescence radiation generated by at least one luminophore in at least one aperture or slit in a substrate, the at least one aperture or slit having a smallest dimension and being filled with a medium such as a liquid or a gas. The method comprises:

exciting the at least one luminophore by means of an excitation radiation at a first side of the substrate, the excitation radiation having a wavelength, in the medium that fills the aperture or slit, the wavelength being larger than the smallest dimension of the at least one aperture or slit, and

detecting luminescence radiation coming from the at least one excited luminophore at a second side of the substrate, the second side being opposite to the first side.

The wavelength of the excitation radiation in the medium that fills the aperture or slit may be at least a factor 2 larger than the smallest dimension of the at least one aperture or slit.

According to embodiments of the invention, where the substrate may comprise at least one slit, the excitation radiation may consist of polarized light, e.g. TE polarized light (electric field directed along the dimension of e.g. a slit). However, in other embodiments, the polarized light may also be TM polarized light. In this case, it may be easier to collect emitted luminescence. For, for example, a circular aperture the kind of polarization is not relevant. For a rectangular aperture, polarization may also be relevant because it may have an impact on the decay length of the evanescent field.

The method according to the invention may, according to embodiments of the invention, furthermore comprise immobilizing ligands onto inner surface walls of the at least one aperture or slit. This may be done e.g. via suitable surface chemistry. The choice of surface chemistry merely depends on the chemical composition of the inner surface walls.

According to the invention, polarizing filters may furthermore be used to improve the suppression of the excitation wavelength. Alternatively, other types of filters may be used such as, for example, a wavelength filter that blocks (or partly blocks, i.e. attenuates) or redirects (like a dichroic beam splitter) the excitation light while the fluorescence is substantially unaffected.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

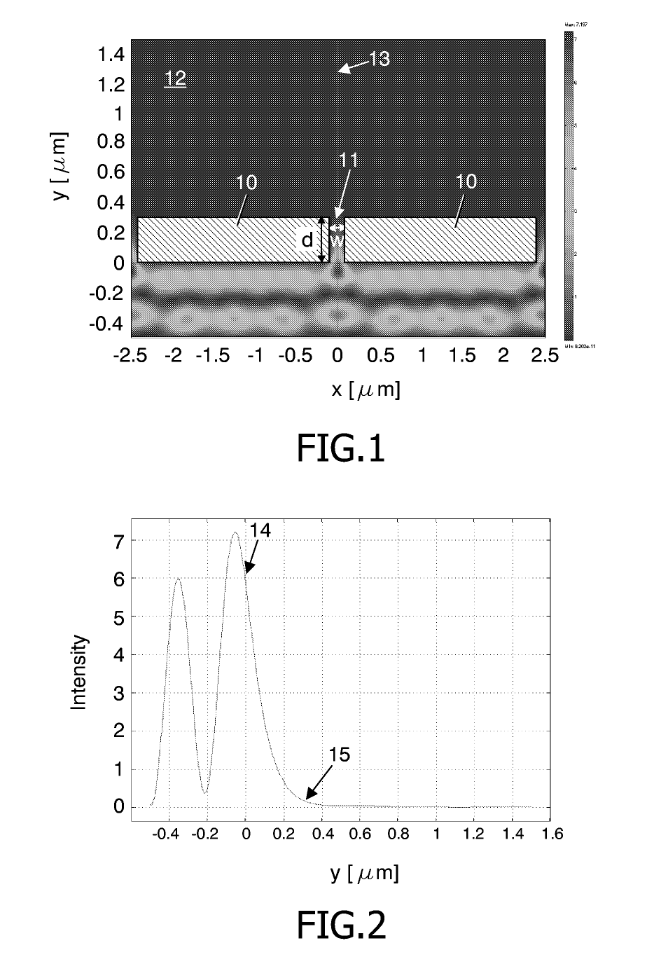

FIG. 1 shows the intensity distribution of a FEMLAB finite element simulation, using an aperture structure with a width w of 200 nm and a depth d of 300 nm and an excitation by a plane wave.

FIG. 2 is a plot of the intensity of radiation generated by a plane wave along the direction of propagation through the centre of the aperture as in FIG. 1.

FIG. 3 is an intensity distribution in the x-y plane for the slit of FIG. 1 and for excitation by a Gaussian beam.

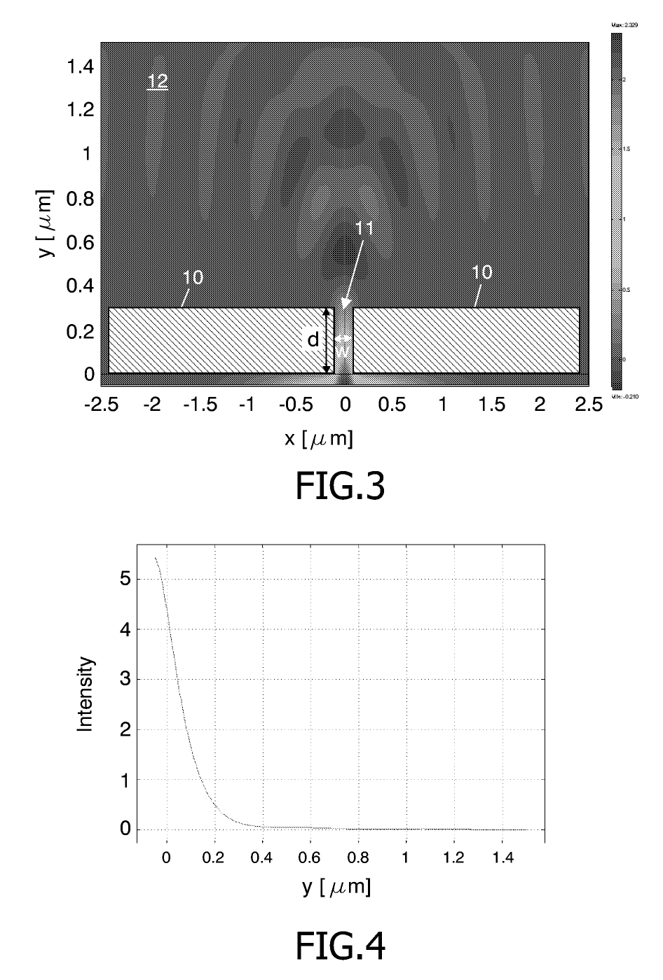

FIG. 4 is a plot of the intensity along a line in the y-direction of FIG. 3 through the centre of the aperture.

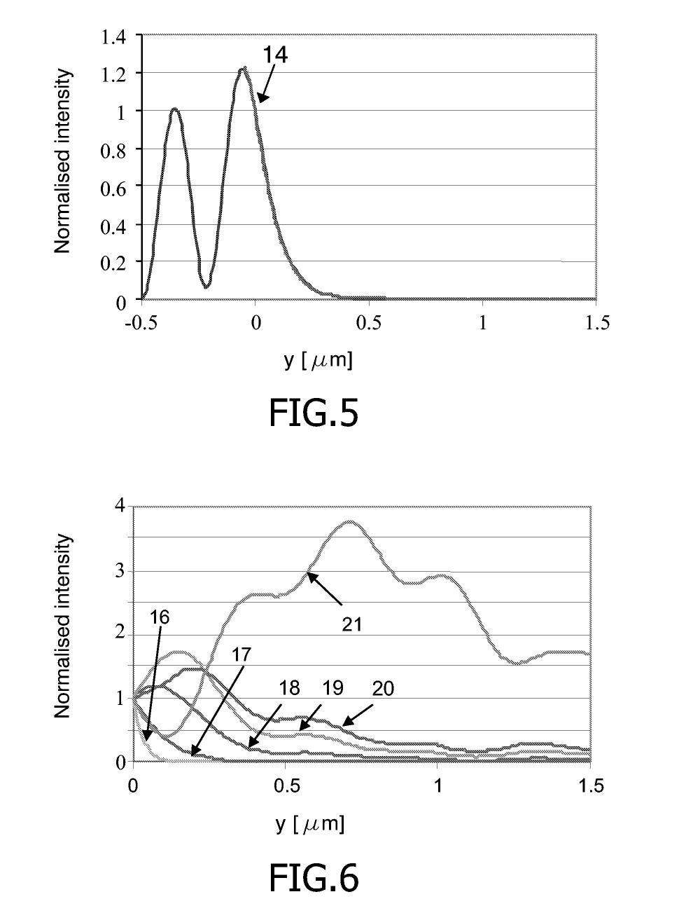

FIG. 5 is a normalised (y=0) plot of the intensity along a line in the y-direction through the centre of the aperture, corresponding to the situation in FIG. 2 and FIG. 4.

FIG. 6 illustrates the impact of increasing width of the aperture on the intensity distribution.

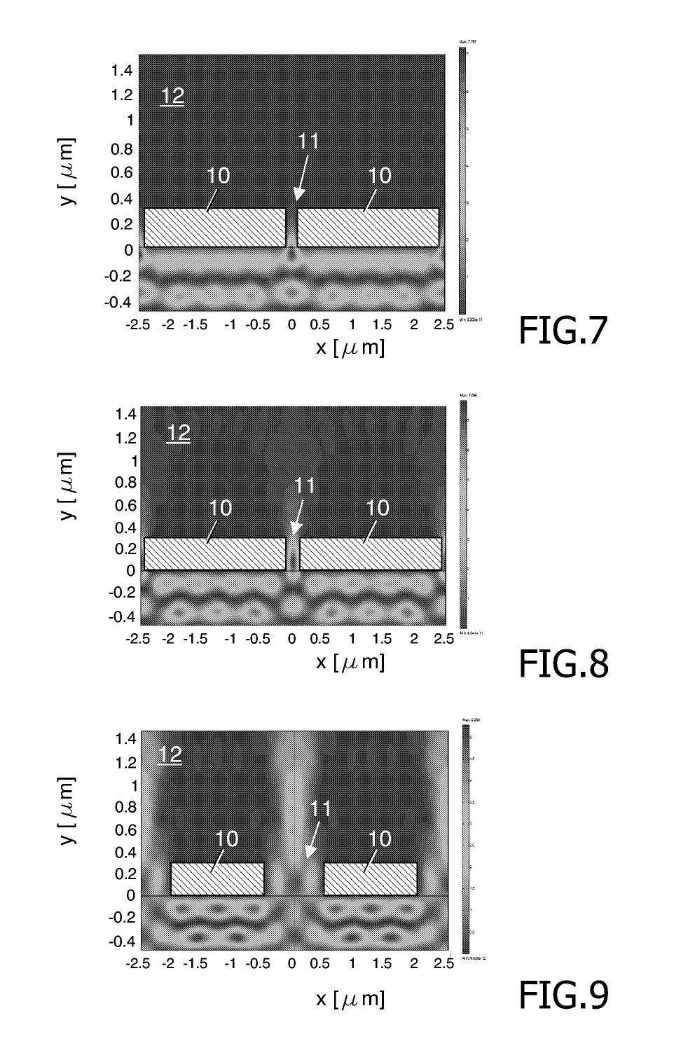

FIG. 7 shows the intensity distribution for a pinhole with width w=0.2 μm.

FIG. 8 shows the intensity distribution for a pinhole with width w=0.26 μm.

FIG. 9 shows the intensity distribution for a pinhole with width w=1 μm.

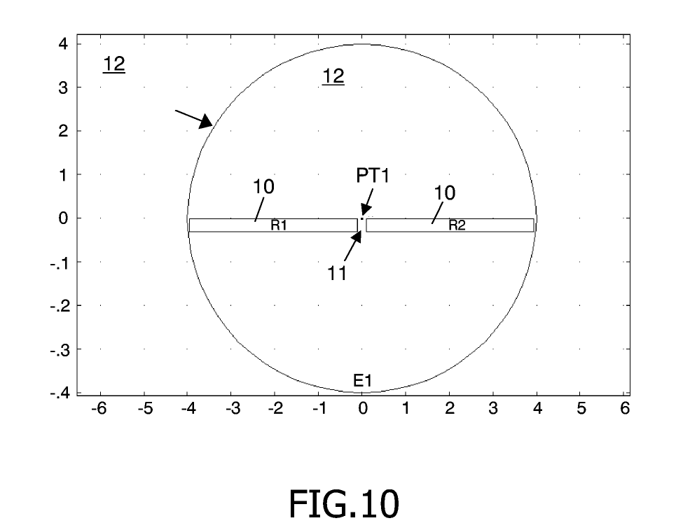

FIG. 10 illustrates the geometry used for 2D calculation of radiation emission of a fluorophore in the presence of an aperture or slit.

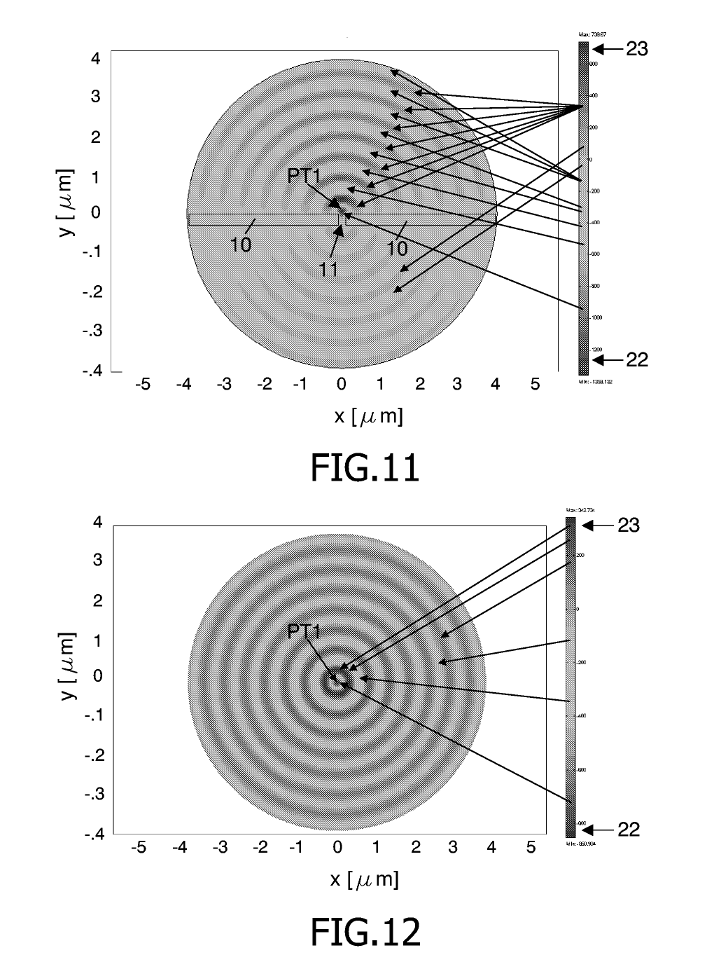

FIG. 11 shows a radiation pattern generated by a fluorophore positioned at the exit side of a 0.2 μm wide aperture.

FIG. 12 shows a radiation pattern generated in the absence of an aperture.

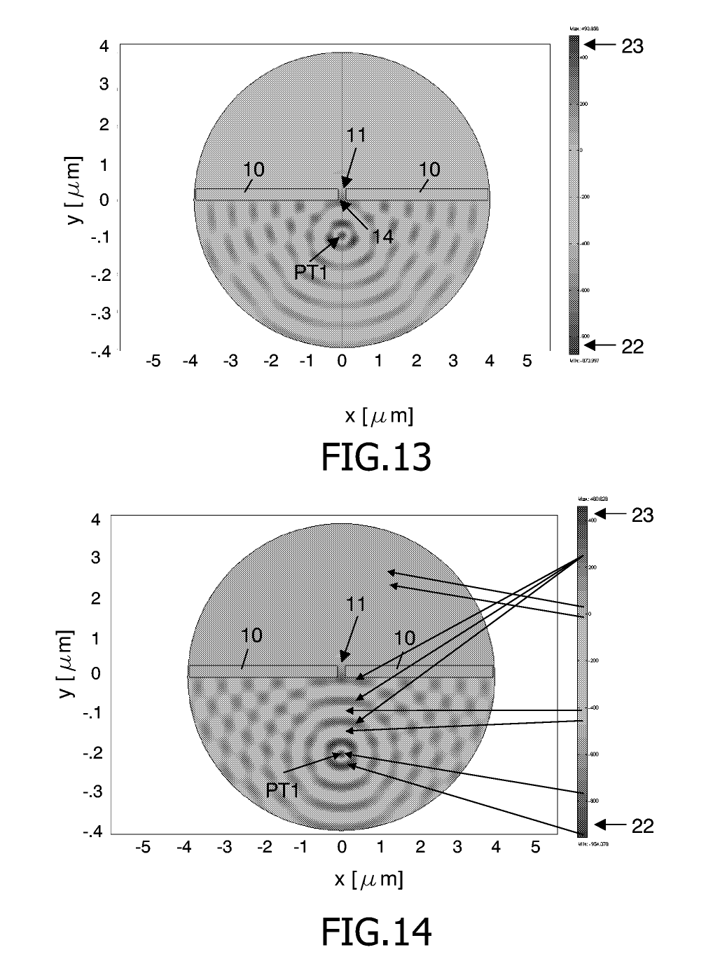

FIG. 13 shows a radiation pattern generated by a dipole positioned 1 μm in front of an aperture.

FIG. 14 shows a radiation pattern generated by a dipole positioned 2 μm in front of an aperture.

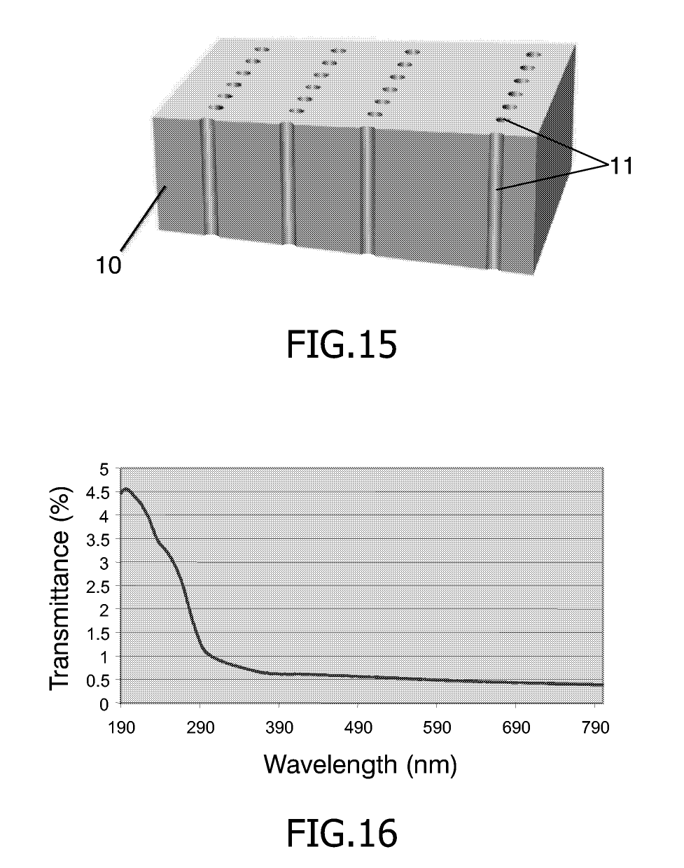

FIG. 15 schematically illustrates a pore array filter with holes through the entire substrate.

FIG. 16 illustrates light transmittance of an Al-coated pinhole-foil according to an embodiment of the present invention.

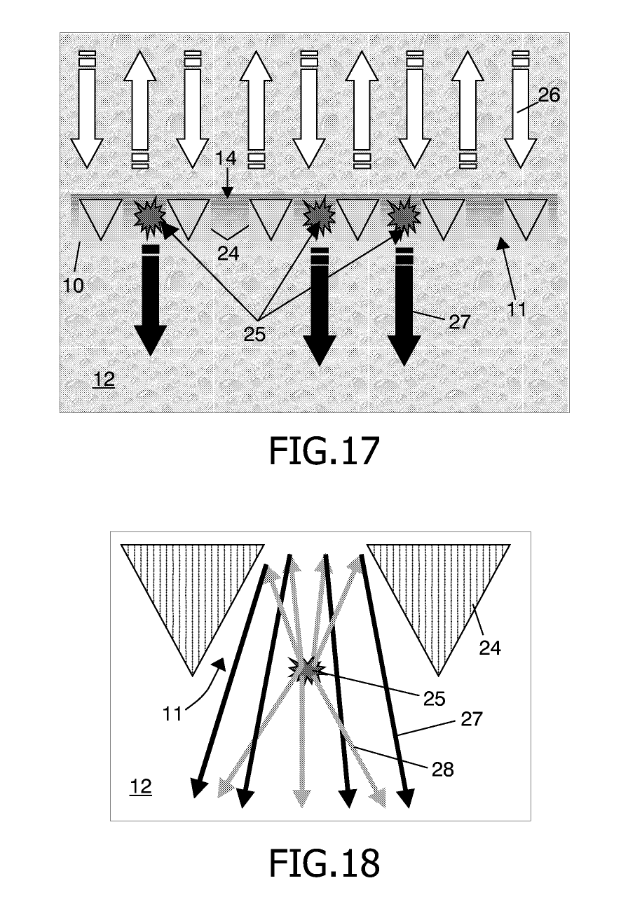

FIG. 17 illustrates a hole structure according to an embodiment of the invention.

FIG. 18 illustrates in more detail the reflection of emitted fluorescence in the hole structure of FIG. 17.

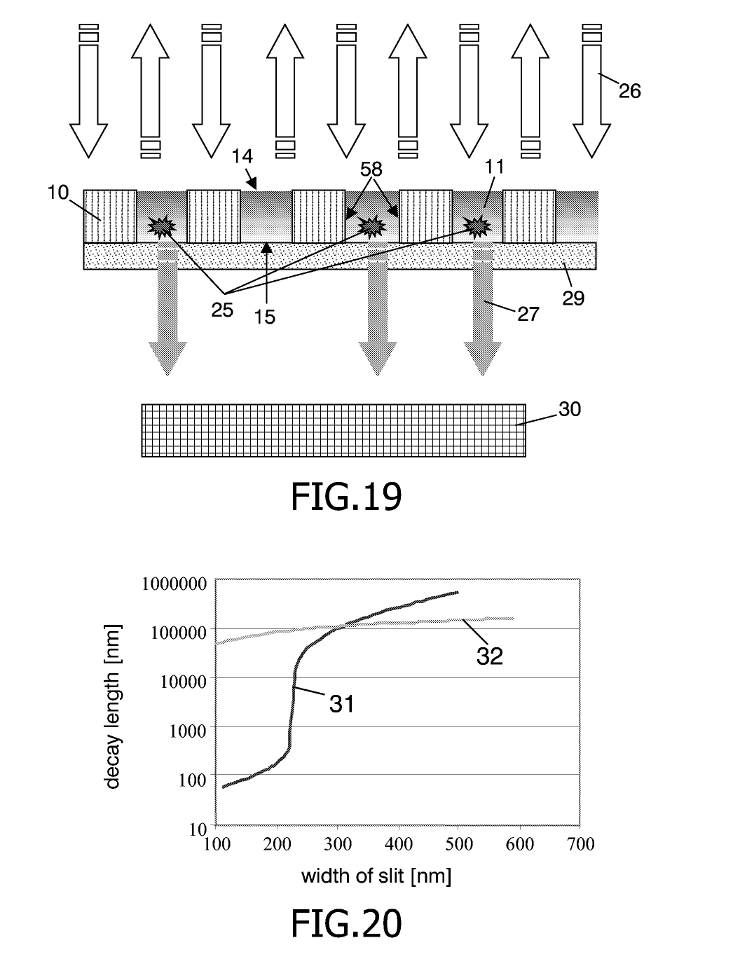

FIG. 19 illustrates a hole structure according to an embodiment of the invention.

FIG. 20 illustrates the decay length (1/e)̂2 intensity for the propagation of the fundamental mode of radiation through a slit.

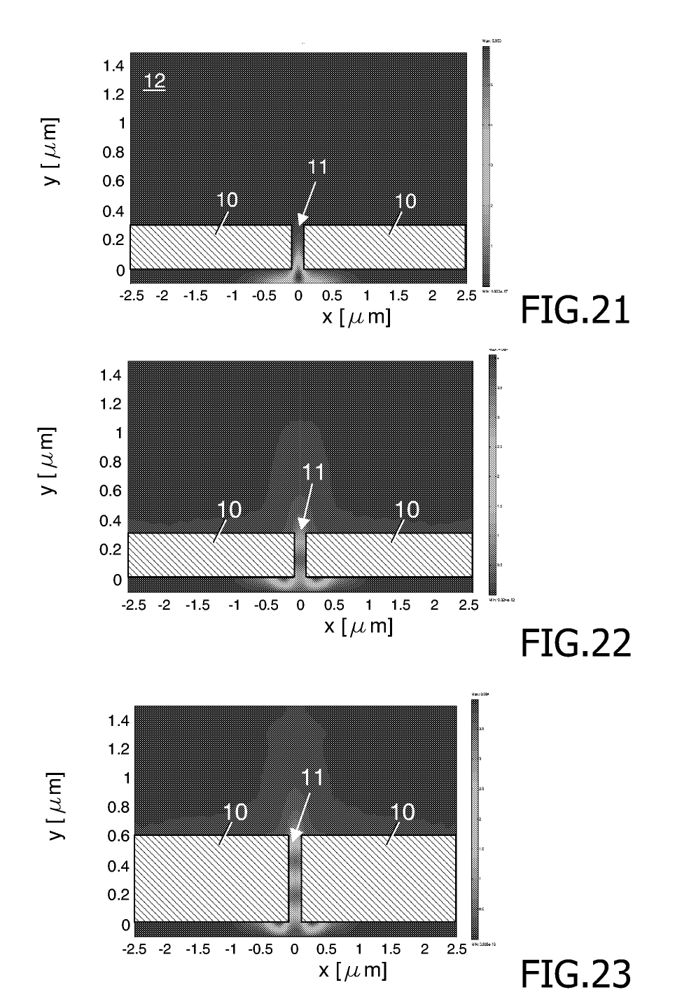

FIG. 21 shows the intensity distribution for a 300 nm thick slit and TE polarized light.

FIG. 22 shows the intensity distribution for a 300 nm thick slit and TM polarized light.

FIG. 23 shows the intensity distribution for a 600 nm thick slit and TM polarized light.

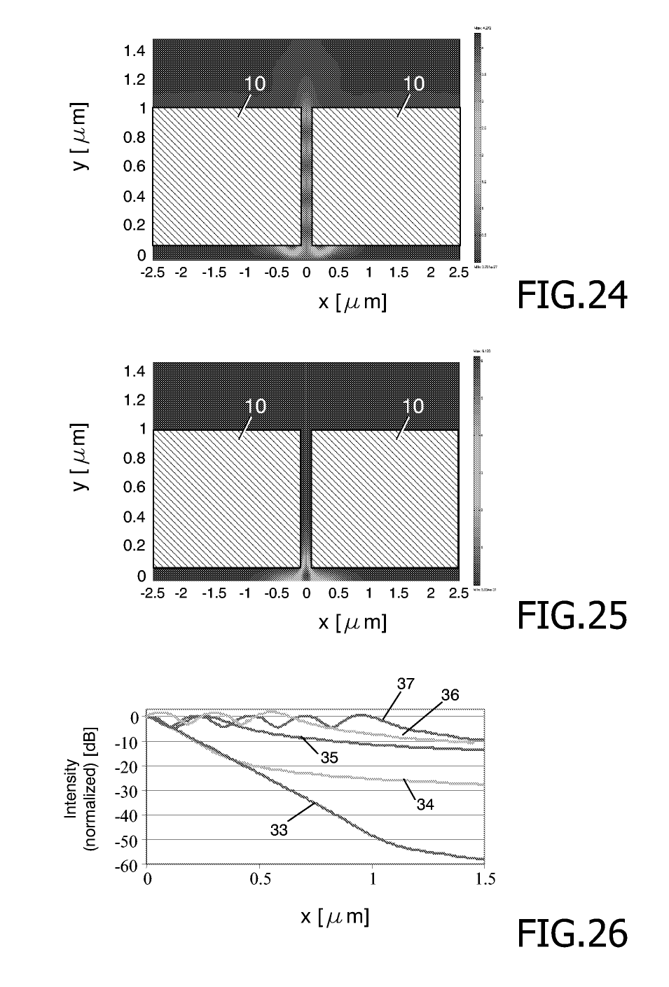

FIG. 24 shows the intensity distribution for a 1000 nm thick slit and TM polarized light.

FIG. 25 shows the intensity distribution for a 1000 nm thick slit and TE polarized light.

FIG. 26 shows the normalised intensity (normalised with respect to intensity at x=y=0) along the centre line of the slit for TE and TM polarization and for different thicknesses of apertures.

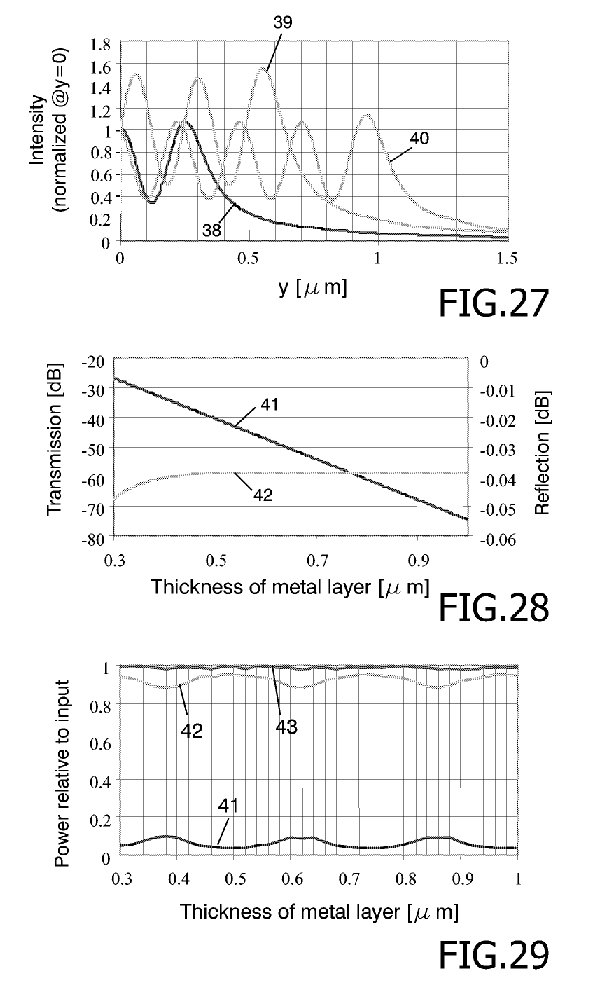

FIG. 27 shows the normalised intensity (normalised with respect to intensity at x=y=0) along the centre line of the slit for TM polarization.

FIG. 28 shows transmission and reflection for an array of slits formed in a metal substrate (width of 200 nm and distance of 2.5 μm between slits) for TE polarized light.

FIG. 29 shows transmission and reflection for an array of slits formed in a metal substrate (width of 200 nm and distance of 2.5 μm between slits) for TM polarized light.

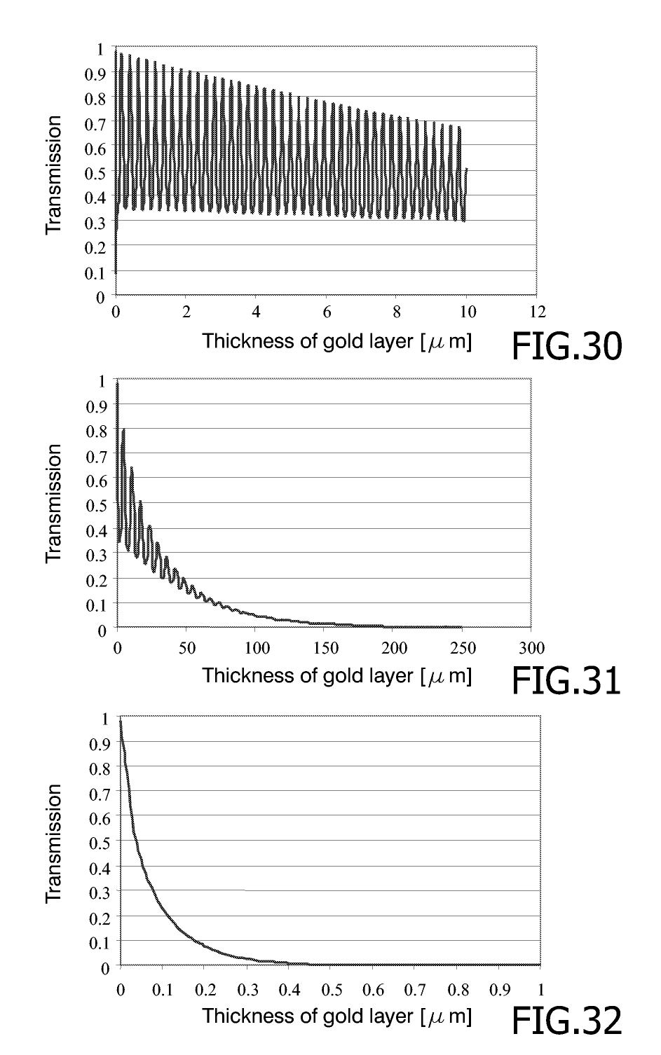

FIG. 30 and FIG. 31 show transmission of a periodic array of slits (period of 0.4 μm) for TM polarized light as a function of the thickness of a gold substrate layer.

FIG. 32 shows transmission of a periodic array of slits (period of 0.4 μm) for TE polarized light as a function of the thickness of the gold substrate layer.

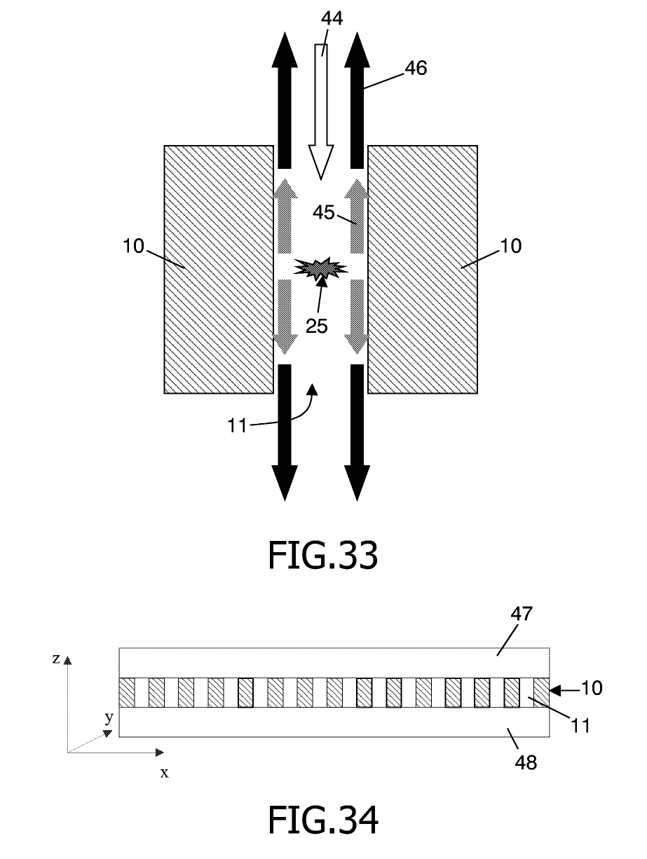

FIG. 33 illustrates excitation radiation and luminescence radiation in a slit structure according to a further embodiment of the invention.

FIG. 34 is a cross-section of a nano-fluidic channel according to yet another embodiment of the present invention.

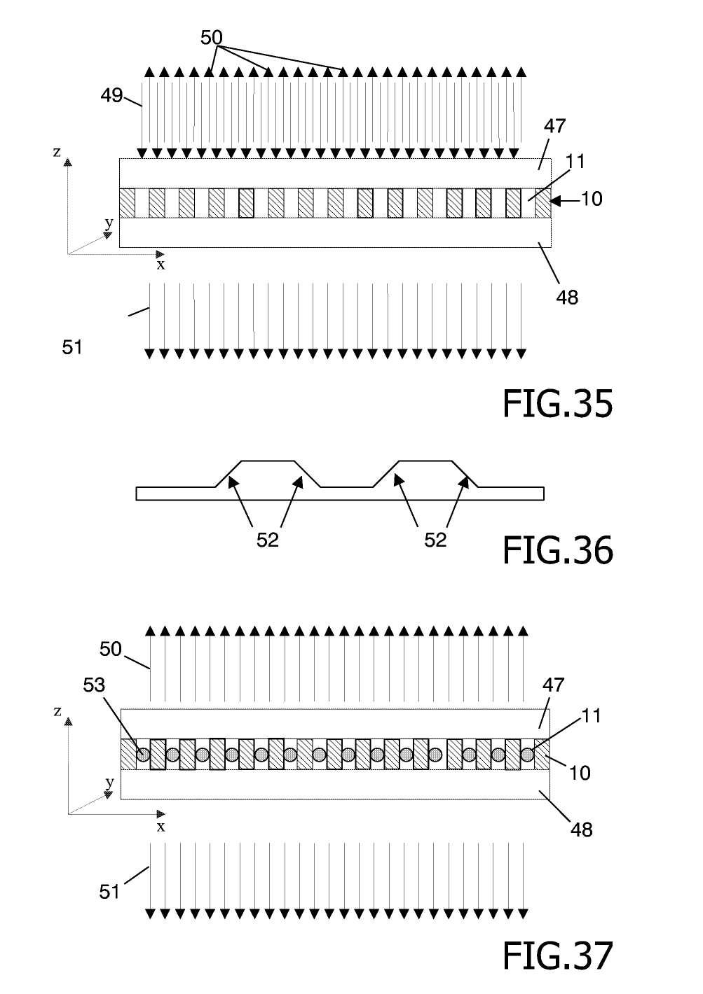

FIG. 35 illustrates the excitation of fluorophores dissolved in a fluid through an upper slab of the fluid channel of FIG. 34.

FIG. 36 shows a patterned slab.

FIG. 37 illustrates excitation of fluorophores dissolved in a fluid and directed in a direction parallel to the slabs.

In the different figures, the same reference signs refer to the same or analogous elements.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The present invention provides a qualitative or quantitative sensor system, more particularly a luminescence sensor system, which may for example be a luminescence biosensor system or luminescence chemical sensor system, which shows good signal-to-background ratio. Hereinafter, the present invention will mainly be described with reference to a luminescence biosensor system, but this is only for the ease of explanation and does not limit the invention.

The luminescence sensor system according to embodiments of the invention allows separation of the excitation and luminescence radiation, e.g. fluorescence radiation.

The present invention will be described with respect to a sensor system comprising a sensor for being immersed in a fluid, an excitation radiation source, and a detector. However, this is not limiting the invention. The sensor according to the present invention comprises at least one aperture or slit which is to be filled with a medium. The sensor does not need to be immersed in the medium; the medium may also e.g. be sprayed over the sensor and into the at least one aperture or slit.

The luminescence sensor according to the invention comprises a substrate which is provided with at least one aperture, such as e.g. a hole, gap or any other kind of opening, such as e.g. at least one slit. According to the invention, the at least one aperture may have any suitable shape, such a e.g. a square, circular, elliptical, rectangular, polygonal, . . . shape. Moreover, an aperture may have two or three dimensions. Therefore, when in the further description is talked about the dimension of an aperture, the smallest dimension of the aperture is to be considered. The aperture or slit structure in the substrate may preferably be used with evanescent excitation. The luminescence radiation can be obtained in solution or on a substrate. The use of an aperture or slit structure according to the present invention can eliminate the need for filters to separate excitation and luminescence radiation. In addition, the same aperture or slit structure is suitable to be used with different or multiple excitation wavelengths. Different wavelengths, however, also imply different decay constants for an evanescent field. For a given width and by decreasing the wavelength there comes a point where the aperture or slit is larger than the diffraction limit for that wavelength in the fluid the sensor is immersed in or the aperture or slit is filled with. This means that the width of the aperture or slit needs to be chosen such that it is suitable for all wavelengths and this also means that the range of possible wavelengths may be slightly limited.

First, the operation principle of evanescent fields reflecting on an aperture or slit structure will be explained and a more detailed discussion of evanescent excitation will be given. It has, however, to be understood that the invention is not limited to evanescent excitation. For explaining the operation principles of evanescent fields, several finite element simulations are performed in order to explain the evanescent fields that may be used according to the present invention for exciting luminophores, such as e.g. fluorophores.

In the following discussion, detection of luminescence radiation is performed in transmission mode, this means that the sensor is irradiated with excitation radiation coming from an excitation radiation source at a first side of the sensor and luminescence radiation is detected at a second side of the sensor, the second side being opposite to the first side.

Referring to FIGS. 1-3, the discussion is made with reference to a substrate 10 comprising a slit structure 11 and hence forming a porous substrate 10. However, it has to be understood that the invention is not limited to this but also may be used in case of aperture structures, such as e.g. holes, gaps, or other openings formed in a substrate 10. FIGS. 1 and 3 show an intensity distribution of a finite element simulation of a substrate 10, for example a metal substrate, e.g. a gold substrate, or a semiconductor substrate, e.g. a silicon substrate, comprising a slit structure 11. The main requirement for the substrate material is that it is not transparent for the excitation radiation, i.e. that the material between the apertures is not transparent for the excitation radiation. The finite element simulation is made by means of FEMLAB, an interactive software to model single and coupled phenomena based on partial differential equations (PDEs), which software is obtainable from the Comsol Group.

Simulations have been performed in 2D for a slit 11 and, unless mentioned otherwise, for TE polarized light. The conclusions obtained by performing these simulations are, however, also valid for 3D apertures like, for example, pinholes, for which the polarization is irrelevant due to symmetry.

In a first simulation, as illustrated in FIG. 1, an array of slits 11 having a width w of 200 nm formed in a 300 nm thick gold layer (index, n=0.038361519−j*5.074565) as a substrate 10, each slit 11 of the array of slits 11 thus having a depth d of 300 nm, is illuminated with a plane wave having a wavelength λ of 700 nm in order to see the evanescent field inside the slit 11. For the simplicity of the drawing, in FIG. 1 only one slit 11 of the array of slits 11 is shown. This is not limiting to the invention. The array of slits 11 may be a periodic array of slits 11, i.e. an array having an equal distance between neighbouring slits 11. However, this does not need to be so; the distance between neighbouring slits 11 may also be different. In the example given, the array of slits 11 is a periodic array wherein the distance between centres of neighbouring slits 11 in the substrate 10 may be 2.5 μm. The porous substrate 10 with slits 11 is immersed in an immersion fluid 12 such as e.g. water or air. In this example, the TE polarization of the, i.e. the electric component of the light, is considered.

From FIG. 1 it can be seen and from simulations it follows that almost no light is being transmitted by the slit structure 11, when the dimension of the slit structure 11 are smaller than half the wavelength of the incident radiation. In general, in order for the radiation not to enter the apertures or slits 11, evanescent waves are required, which are waves with spatial frequencies beyond the diffraction limit. This means that for a given wavelength λ and refractive index n of the medium that fills the apertures or slits 11, i.e. e.g. the medium in which the sensor is immersed, the smallest dimension of the aperture or slit structure 11 should be smaller than λ/(2*n). Thus, an evanescent field is able to penetrate into the apertures or slits 11 if use is made of an aperture or slit structure 11 comprising apertures or slits 11 with a width smaller than the diffraction limit in the immersion fluid 12, e.g. smaller than 270 nm for water (at an excitation wavelength of 700 nm) if the structure is immersed in water. FIG. 2 shows the intensity distribution of the light when traveling through the slit 11 (along the line indicated by reference number 13 in FIG. 1).

In FIG. 2 the evanescent field between the entrance 14 and exit 15 of the slit 11, illustrated in FIG. 1, can be seen. The intensity drops with 1/e² within ˜180 nm when travelling through the slit 11 along the line indicated by reference number 13 in FIG. 1. For example, directly behind the slit 11 the intensity has dropped to 3.1% of the intensity at the entrance 14 while at a distance of 1 μm behind the slit 11, the intensity has dropped to only 0.3% of the intensity at the entrance 14 of the slit 11. It should be remarked that the shape of the evanescent field may be tuned by varying the width w and depth d of the slit 11, or more in general, the width w and depth d of the aperture 11.

For optimal binding capacity of the sensor (i.e. the highest surface area), it is preferred to have large depths d and a small pitch, i.e. a small distance between the apertures or slits 11, which determines the porosity of the filter. As an example, the case of a 200 nm square and 300 nm deep hole 11 and a porosity of the filter of 50% may be considered, which gives an effective surface area of 4*200*150=120000 nm² per aperture 11. The intensity rapidly drops inside the aperture 11, and therefore, an effective depth of 0.5*300=150 nm is considered. One may also take the 1/ê2 intensity (relative to the input intensity) as a measure for the effective depth, which in that case is 180 nm. Per aperture 11 there is, at the input facet of the filter, a flat area of 200 nm*200 nm=40000 nm². Taking into account that the porosity of the filter is 50%, an equivalent flat area of 80000 nm² can be found. From this and with a circumference of 4*200 nm=800 nm and an effective depth of 150 nm, an area of 800 nm*150 nm=120000 nm² per hole 11 may be achieved. This adds up to an increase of the effective area by a factor of 120000 nm²/80000 nm²=1.5. By optimising the diameter of the apertures or slits 11, the shape of the evanescent field, i.e. the penetration depth into the aperture or slit 11 can be tuned and the effective surface area can be varied and/or optimised.

Using evanescent fields for the excitation of luminophores, e.g. fluorophores, results in a small excitation volume localised around the position of the aperture or slit 11. By small excitation volume is meant that, in practice, the apertures or slits 11 only transmit excitation radiation into a small volume localised around the position of the aperture or slit 11. This may be utilised for localised probing of the luminescence radiation and for minimising the ratio of the luminescence radiation generated behind the aperture or slit 11 and the luminescence radiation generated inside the aperture or slit 11. The luminescence radiation may e.g. be fluorescence radiation.

In a second simulation, in order to show that also focussed Gaussian beams may be used for illuminating a slit 11 as illustrated in FIG. 1, a calculation is performed using exactly the same parameters as in the first simulation, but now using a Gaussian beam with a waist, i.e. a distance from maximum that corresponds with 1/e amplitude, of 0.5 μm. The results of the calculation are shown in FIGS. 3 and 4.

In order to compare the first and second simulation, FIG. 5 shows the intensity profiles given in FIGS. 2 and 4, normalised to the intensity at the entrance 14 of the slit 11. From FIG. 5, it can be seen that the evanescent wave behind the entrance 14 of the slit 11 for a plane wave (simulation 1) and a Gaussian beam (simulation 2) is almost the same. Taking into account that it is preferred to have a high excitation power, it follows that excitation with a Gaussian beam or with a focussed spot having another shape may be preferred. The fact that focussed spot excitation gives an almost identical shape of the evanescent field also indicates that the method is not very sensitive for the angle and shape of the incident light.

In a third simulation, the impact of the width w of the aperture or slit 11 on the intensity of the light behind the aperture or slit 11 is illustrated. This third simulation will be discussed by means of a slit 11 as an aperture. In this simulation, light is used having a wavelength λ of 700 nm and a slit 11 having a depth of 300 nm. FIG. 6 shows normalised intensity curves for slit 11 having a width w of 0.1 μm (curve 16), 0.2 μm (curve 17), 0.26 μm (curve 18), 0.3 μm (curve 19), 0.4 μm (curve 20) and 1 μm (curve 21). From this simulation it can be concluded that a wider slit 11 (increasing width w of the aperture or slit 11) results in a larger penetration depth of the light into the slit 11 and a higher intensity behind the slit 11 (y>0.3 μm), the lower the intensity at the output or exit 15 of the slit 11, the lower the intensity behind the slit 11. The intensity inside the slit 11 decreases exponentially behind the entrance of the slit 11 (y>0 μm), for widths w sufficiently lower than the diffraction limit in the immersion fluid 12, i.e. curves 16, 17, 18 in the simulation shown, as for the illustration given this immersion fluid is water with a diffraction limit of about 270 nm. It can thus be concluded that, to obtain a sufficiently low excitation intensity behind the slits 11, or in general behind the apertures or slits 11, these apertures or slits 11 should have a width w or, in general, should have a smallest dimension, which is lower than the diffraction limit in the immersion fluid 12.

As an illustration, the intensity distribution for apertures, more specifically holes 11, having different widths w, i.e. w=0.2 μm, w=0.26 μm and w=1 μm, are shown in respectively FIG. 7, FIG. 8 and FIG. 9.

Besides for evanescent excitation of the luminophores, e.g. fluorophores, the apertures or slits 11 also have a function to direct the generated fluorescence towards the detector and have a strongly reduced transmission for luminescence originating from positions away from the aperture or slit 11. FIG. 10 shows the geometry used for 2D calculation of radiation emission of a luminophore, e.g. fluorophore, in the presence of an aperture or slit 11 when excitation light comes from the bottom. In the calculations, the luminophore, e.g. fluorophore, is represented by a point (current) source PT1. The wavelength used in the calculations is 700 nm and the TE polarization of the light is used.

FIG. 11 shows a specific example of a radiation pattern generated by a fluorophore, indicated by PT1, positioned at the exit side 15 of a pinhole 11, the pinhole 11 having a width of 200 nm. The figure shows the real part of the electric field in the direction substantially normal to the plane of the paper, the real part of the electric field varies from positive to negative similar to a plane wave. The scale indicated in the figure hence runs from large negative (indicated by arrow 22) to large positive (indicated by arrow 23). The fluorophore PT1 is excited with a radiation source under the hole 11. From the figure it can be seen that the radiation, which is assumed to be TE polarized, is concentrated in a direction normal to the plane of the hole 11. This allows the use of low numerical aperture (NA) optics for collecting the luminescence, in the example given the fluorescence emission. The total power flow running through the upper part of the figure is 96.6% versus 3.4% going downwards. This indicates that almost all the light that was emitted downwards by the fluorophore PT1 is now going up. From this an enhancement in fluorescence power is found of a factor 1.93 (96.6%/0.5).

FIG. 12 shows an analogous calculation, but now in free space without the presence of a (patterned) slit 11. As expected, in this case 50% of the power generated by the fluorophore PT1 being excited flows upwards, and 50% flows downwards.

In reality, not only luminophores, such as e.g. fluorophores, located at the aperture or slit 11 will luminesce, but also luminophores, such as e.g. fluorophores, outside the aperture or slit 11 and inside the excitation beam will luminesce. In this paragraph, the impact of luminescence, e.g. fluorescence, generated outside the aperture or slit 11 will be estimated. FIG. 13 shows the intensity distribution for the specific example of a background fluorophore PT1, i.e. a fluorophore PT1 at 1 μm distance from the slit 11 which is located on the excitation side of the hole 11. The simulation shows that there is excellent suppression by the hole 11, because only 0.285% of fluorescent power is transmitted through the hole 11 to the detection side, which is one order of magnitude lower than for a fluorophore PT1 located at the entrance 14 of the hole 11. This corresponds with a suppression of fluorescent power behind the slit 11 by a factor of 0.5/0.00285=175, compared with the case where no slit 11 is present. Similarly, FIG. 14 shows the intensity distribution of a fluorophore PT1 positioned at 2 μm distance from the hole 11. In this case only 0.149% of fluorescent power is transmitted by the hole 11, corresponding with a suppression of fluorescent power by a factor 0.5/0.00149=336, compared with the case where no slit 11 is present. In both FIG. 13 and FIG. 14 it can be seen that the fluorescence does not substantially cross over to the detection side.

From the above described finite element simulations, it can in general be concluded that:

1. Illuminating apertures or slits 11 or an array of apertures or slits 11 with widths w or with a smallest dimension below the diffraction limit of the immersion fluid 12 results in a small excitation volume, which also lies below the diffraction limit dimensions, limited to the direct neighbourhood of the aperture or slit 11.
2. The aperture or slit 11 almost only transmits luminescence radiation, e.g. fluorescence radiation, generated in the direct neighbourhood or inside of the aperture or slit 11: typical suppression for luminophore radiation, e.g. fluorophore radiation, away from the aperture or slit 11 is better than two orders of magnitude.
3. The apertures or slits 11 concentrate the luminescence, e.g. fluorescence, in a direction normal to the plane of the apertures or slits 11.

Next, it will be demonstrated that transmission of luminescence radiation is significantly suppressed for waves travelling through a small aperture or slit 11, i.e. for wavelengths larger than 20% of the slit or aperture dimension, transmission of luminescence radiation is significantly suppressed. In order to study the effect of deep apertures or slits 11 on the light transmission, a 100 μm thick silicon foil with micro pores or apertures 11, as illustrated in FIG. 15, is used. The light transmittance of the pinhole-foils is measured and the result is shown in FIG. 16. From this figure it can be seen that the light transmittance stays low (˜0.5%, as expected for an Al layer) for higher wavelengths, i.e. for wavelengths above 350 nm, but for UV wavelengths shorter than 300 nm the transmittance increases to 4.5% at 200 nm, where a closed Al layer, i.e. a layer with no apertures nor slits 11, would not have any UV transmittance. It has to be noted that these results are for fairly large holes (˜1.5 μm). For smaller holes, the minimum transmittance will be lower than was measured here.

Hereinafter, embodiments of the invention will be described.

In a first embodiment of the present invention, a sensor such as, for example, a biosensor, is provided which comprises a wafer substrate 10 provided with apertures 11, which in this embodiment may be holes 11, hence forming a porous substrate 10. In embodiments of the present invention, the term “substrate” may include any underlying material or materials that may be used, or upon which a device, a circuit or an epitaxial layer may be formed, provided that at least part of it is not transparent for the excitation light. In other alternative embodiments, this “substrate” may include a semiconductor substrate such as e.g. a doped silicon, a gallium arsenide (GaAs), a gallium arsenide phosphide (GaAsP), an indium phosphide (InP), a germanium (Ge), or a silicon germanium (SiGe) substrate. The “substrate” may include for example, an insulating layer such as a SiO₂ or an Si₃N₄ layer in addition to a semiconductor substrate portion. Thus, the term substrate also includes silicon-on-glass, silicon-on sapphire substrates. The term “substrate” is thus used to define generally the elements for layers that underlie a layer or portions of interest. Also, the “substrate” may be any other base on which a layer is formed, for example a glass, plastic or metal layer. The main constraint is that the material of the substrate 10 next to the apertures 11 is not transparent for the excitation light, i.e. has a large attenuation. This implies that at least part of the stack where the apertures 11 extend into should be non-transparent for the excitation light.

The holes 11 in the substrate 10 may have dimensions smaller than the wavelength of the excitation radiation, preferably smaller than 50% of the wavelength of the excitation radiation in the medium (immersion fluid 12) that fills the apertures 11, in order to have evanescent wave excitation, more preferred smaller than 40% of the wavelength in the medium that fills the apertures 11, which is also expressed as the fact that the holes 11 may have sub-wavelength sizes. The substrate 10 may comprise an array of holes 11. The array of holes 11 may be a periodic array of holes 11, i.e. the distance between the centres of neighbouring holes 11 may be the same. However, this does not necessarily have to be so. The distance between neighbouring holes 11 may also be different such that no periodic array is formed.

In use, the porous substrate 10 with the hole structure 11 may be immersed in an immersion medium 12, which may, for example, be a liquid or a gas such as water or air. The liquid or gas may comprise the substance, for example, beads/molecules or labelled target molecules, to be sensed or detected by the sensor.

In the following description, the terms holes and hole structure will be used for one another for indicating the same thing, i.e. the apertures 11 formed in the wafer substrate 10. According to this first embodiment, the holes 11 may have slanted sidewalls 24. However, this is not limiting to the invention, the holes 11 may also have other shapes. As can be seen from FIG. 17, luminophores 25, which in this embodiment may e.g. be fluorophores 25, are present inside the holes 11, e.g. one luminophore 25 per hole 11. The further description of this embodiment will be described by means of fluorophores 25 and fluorescence, but it has to be understood that this is only for the ease of explanation and that this is not limiting to the invention. The invention also applies to all other kinds of luminophores 25 and luminescence.

The hole structure 11 formed in the substrate 10 is illuminated from above by excitation light (indicated by arrow 26). According to the invention, the holes 11 in the substrate 10 may have sub-wavelength sizes, i.e. dimensions below the wavelength of excitation radiation, which preferably may be below the diffraction limit of the immersion fluid 12 the sensor is immersed in or the aperture or slits are filled with. In order to be below the diffraction limit of the immersion fluid 12, which may be a liquid or a gas, the aperture 11 should have a dimension smaller than half the wavelength inside the medium that fills the aperture 11, i.e. <λ/(2*n); wherein n is the refractive index of the medium that fills the apertures 11 and λ is the wavelength of vacuum.

As discussed already above, the excitation light 26 is unable to propagate through the holes 11 if the holes 11 have sizes below the diffraction limit and, more in general, if the smallest dimension of the apertures 11 is smaller than half the wavelength of the excitation light 26 in the medium that fills the holes 11, in order to have an evanescent wave, i.e. a wave that does not propagate. Hence, at the entrance 14 of the hole structure 11 the excitation light 26 will be reflected due to the small dimensions of the holes 11. An evanescent field is then generated inside the holes 11 and will be reflected, leaving an evanescent field within and behind the holes 11. Fluorophores 25 that are present somewhere in the holes 11 and thus in this evanescent field will be excited and will emit fluorescence radiation (indicated by arrows 27). Because this fluorescence radiation 27 is substantially unable to pass through the holes 11, substantially all the fluorescence radiation 27 will be emitted downwards and is then sent to a detection unit (not shown in the figure) for measuring the fluorescence signal. The detection of the intensity of the fluorescence radiation 27, or more general the luminescence radiation, may be done by any suitable detector, e.g. using charge coupled device (CCD) or complementary metal oxide semiconductor (CMOS) detectors. Alternatively, a scanning approach may be used in which only a small imaging view is obtained. Light is collected on a photodiode for a certain time in such a way that optimal signal to noise may be obtained. This may substantially increase the sensor sensitivity.

It has to be noted that any fluorescence radiation 27 that is going upwards, i.e. radiation generated by the excited fluorophore 25, and that would normally not reach the detection unit, will encounter the hole structure 11, which, as explained above, does not substantially transmit the light. As a result, the upgoing fluorescence radiation 27 is reflected, which roughly results in an increase of the total fluorescence power directed towards the detection unit by a factor 2, and is then pointed down towards the detector unit. Due to the slanted sidewalls 24 of the holes 11, the fluorescence radiation 27 is concentrated in a significantly smaller spatial angle than in the case of no slanted sidewalls 24. This means that extra fluorescence radiation 28 is collected for an optical system with given acceptance angle (i.e., spatial angle) of the detector and optics (numerical aperture) used for imaging the fluorescence on the detector, greatly increasing the sensitivity of the biosensor with about a factor of 10 with respect to results based on a detector as described in WO 02/059583. Alternatively, detectors may be used with lower power acceptance angles and/or optics with lower numerical apertures (NA). FIG. 18 demonstrates how this works. In this figure, the arrows indicated by reference number 28 represent the fluorescence that is emitted by the fluorophores 25. As can be seen, the fluorescence 28 is emitted in all directions. The fluorescence 28 that is directed in the opposite direction than the direction toward the detector, in the example given in the upward direction, will be reflected onto the triangle shaped side walls 24 and redirected in the direction toward the detector. The total fluorescence directed toward the detector is indicated by arrows 27.

Furthermore, fluorophores 25 that are above the hole structure 11, i.e. within the excitation light 26, but not inside a hole 11, are also excited by the excitation light 26. However, the fluorescence 27 generated by these fluorophores 25 is unable to pass through the holes 11, and is therefore not detected. Thus, any fluorescence 27 generated above the hole structure 11 does not substantially contribute to the background signal. A typical suppression of radiation from a fluorophore 25 away from the hole 11 is better than two orders of magnitude.

An advantage is that the excitation beam 26 does not have to be focused—its evanescent field will reach the luminophores 25 inside the hole or slit structure 11—and no special measures need to be taken to achieve multi-spot excitation. With multi-spot excitation is meant that the aperture or slit structure 11 is illuminated with one or more excitation spots, for example with an array of excitation spots. For example, the position of the spots may be matched with the position of the holes 11, which results in a more efficient excitation intensity in the holes/spots. The presence of triangles, i.e. holes or apertures 11 with slanted sidewalls 24 as can be seen from FIG. 17, results in redirection of the rays in such a way that more power of the fluorescence 27 is concentrated in a given spatial angle; resulting in an increase of the amount of collected power for a given numerical aperture of the collecting optics and acceptance angle of the detector.

According to this first embodiment, illuminating (an array of) hole(s) 11 with widths or with a smallest dimension below the excitation wavelength, e.g. less than 50% of the excitation wavelength in the medium that fills the holes or apertures 11, preferably less than 40% of the excitation wavelength in the medium that fills the holes or apertures 11, results in an excitation volume below the diffraction limit:

1. For an array of slits 11 having widths or a smallest dimension below the diffraction limit and being illuminated with TE polarized light, this means that in the direction normal to the plane of the slits 11 and in the direction of the depth of the slits 11, the excitation volume inside and behind the slit has dimensions which are below the diffraction limit, being half the wavelength in the medium that fills the slits 11: 2D evanescent volume. For illumination with TM polarized light, this is not true and the array of slits 11 mainly transmits the excitation light.
2. For an array of apertures 11 with dimensions below the diffraction limit, the excitation volume inside and behind the slit has dimensions below the diffraction limit in all three directions: 3D evanescent volume.

The thickness of the porous substrate 10 does not need to be of the order of the evanescent field penetration depth, but the thicker the porous substrate 10, the less power is transmitted by the array of holes 11. A second substrate may be mounted onto the hole structure 11 or, vice versa, the porous structure 11 may be added to an existing substrate. This may change the mechanical stability of the substrate 10. A prerequisite for this approach is that the second substrate is transparent for at least one of the excitation or emission wavelengths. This will be explained with respect to a second embodiment of the present invention.

A second embodiment of the invention is illustrated in FIG. 19. A first substrate 10 is provided with holes 11 with sub-wavelength dimensions, i.e. with dimensions which are smaller than the wavelength of the excitation radiation in the medium that fills the apertures or slits 11, e.g. less than 50% of the excitation wavelength in the medium that fills the apertures or slits 11, preferably less than 40% of the excitation wavelength in the medium that fills the apertures or slits 11, hence forming a porous substrate 10. In the example illustrated in FIG. 19, the porous substrate 10 is mounted on top of a second substrate 29. It is, however, to be understood that this is only an example and is not limiting to the invention. The second substrate 29 may also be mounted on top of the porous substrate 10.

If the second substrate 29 is positioned between the porous structure 10 and a detector 30, the second substrate 29 should be transparent for the emission wavelengths. If, in other embodiments, the second substrate 29 is positioned between the porous structure 10 and the excitation light source, the second substrate 29 should be transparent for the excitation wavelengths. The second substrate 24 may, for excitation wavelengths in the visible range, for example, comprise glass-like materials such as e.g. quartz, calcium fluoride, borosilicate, etc.

As can be seen from FIG. 19, in the embodiment illustrated excitation light, indicated by arrows 26, illuminates the porous substrate 10 from above. At the entrance 21a of the holes 11, the excitation light 20 is reflected, due to the small width or smallest dimensions of the hole 11 which are below the diffraction limit for the medium that fills the apertures or slits 11. An evanescent field is then generated inside the holes 11. Luminophores, which in this embodiment may be fluorophores 25, that are present in the holes 11 will be excited and will emit fluorescence radiation 27. Because this fluorescence radiation 27 is unable to pass through the holes 11, in practice only fluorescence radiation 27 generated close to the exit 21b of the hole 11, in the example given at the side of the second substrate 24, will be detected by detector 30, provided that the thickness of the porous substrate 10 is sufficiently thick, i.e. somewhat thicker than the decay length of the evanescent field. The detector 30 may be a charge coupled device (CCD) or a complementary metal oxide semiconductor (CMOS) detector. Alternatively, a scanning approach may be used in which only a small imaging view is obtained. Light is collected on a photodiode for a certain time in such a way that optimal signal to noise may be obtained. This may substantially increase the sensor sensitivity.

A problem that may arise in a biosensor using a porous substrate 10 having apertures or holes 11 with sub-wavelength width or with a smallest dimension as described in the above embodiments is that the luminescence, e.g. fluorescence, radiation generated within the apertures or holes 11 may be strongly suppressed before it is able to exit the apertures or holes 11.

In embodiments of the invention where the apertures 11 are formed by circular holes 11, the suppression of light does not depend on the polarization state. However, the polarization state becomes important when using a slit structure 11 instead of a circular hole structure 11. Hereinafter, the effect of polarization state on the suppression of radiation will be discussed. The goal of the following discussion is to analyse the polarization dependence of transmission by a slit 11 and to assess how this may be used in a luminescence biosensor according to an embodiment of the present invention.

The analysis has been performed on a single slit biosensor in water environment with a refractive index of n=1.3 for both the electric and the magnetic component, i.e. for TE and TM polarisations. The slit 11, in this analysis, is made in a gold substrate 10 with refractive index n=0.038361519−j*5.074565 and has a width of 200 nm. The wavelength λ of the excitation radiation is 700 nm. In the simulations, it is assumed that the slit 11 is infinitely extended into the direction normal to the plane of the simulation. It is not intended to limit the present invention to the above values of the simulation.

By solving the fundamental modes that propagate through a slit 11, the decay length can be determined. This is illustrated in FIG. 20 in which the decay length for TE (curve 31) and TM (curve 32) polarization light in a slit 11 in a gold substrate 10 is given as a function of the width of the slit 11. This figure clearly shows that the decay length for propagation of the TE polarized fundamental mode is significantly smaller than for the TM polarized mode for the case of a slit 11 with a width below the diffraction limit of water, i.e. below 270 nm.

FIGS. 21 to 25 show intensity distributions for a 300 nm thick slit 11 and TE polarized light (FIG. 21) and TM polarized light (FIG. 22), for a 600 nm thick slit 11 and TM polarized light (FIG. 23) and for a 1000 nm thick slit 11 and TM polarized light (FIG. 24) and for a 1000 nm thick slit 11 and TE polarized light (FIG. 25).

FIGS. 26 and 27 show the normalised intensity (normalised with respect to intensity at x=y=0) along the centre (x=0) of the slit 11. FIG. 26 shows the polarization dependence of transmission on a logarithmic scale [dB] for a slit 11 with a width of 200 nm, with a depth of 1000 nm (curve 33) and 300 nm (curve 34) with TE polarized light and for a slit 11 with a width of 200 nm and a depth of 300 nm (curve 35), 600 nm (curve 36) and 1000 nm (curve 37) with TM polarized light. FIG. 27 shows the intensity along the centre line of a slit 11 for TM polarized light and for a slit 11 with a depth of 300 nm (curve 38), 600 nm (curve 39) and 1000 nm (curve 40).

From FIGS. 21 to 27 it can be concluded that:

1. Transmission for TM is significantly larger than for TE polarization.
2. Intensity pattern for TM polarized light looks like a standing wave (interference pattern in the y-direction).
3. Standing wave pattern (for TM polarization) is also present for longer lengths.
4. There seems to be some kind of resonance effect (normalised intensity inside slit 11 for 600 nm thick gold layer is higher than normalised intensity for 300, 1000 nm thick gold layer).

Transmission of radiation through a single slit 11 shows a strong polarization dependence: transmission for TE polarization state (E field parallel to the slits 11) is significantly lower than for TM polarization state. The intensity distribution for TM polarized radiation inside the slit 11 is a standing wave pattern which indicates a Fabry-Perot effect; this is also supported by the stronger maximum normalised intensity for a slit height of 600 nm, i.e. the resonant effect. Behind the slit 11, the intensity rapidly drops which is attributed (like for TE polarization) to divergence in the free space behind the slit 11.

Next, the impact of the thickness of the substrate 10, in the example given the gold layer, is observed, the substrate 10 comprising an array of slits 11 having the same width as in the above analysis, i.e. 200 nm, and with a distance of 2.5 μm between two neighbouring slits 11. The thickness of the slits 11 depends on and is the same as the thickness of the substrate 10. FIG. 28 shows the transmission (curve 41) and the total reflection (curve 42) for the array of slits 11 for TE polarized light having a wavelength of 700 nm. FIG. 29 shows the total transmission (curve 41) and total reflection (curve 42) for the array of slits 11 in the gold substrate 10 for TM polarized light having a wavelength of 700 nm. Curve 43 in FIG. 29 shows the transmission+reflection. The simulation tool used is a GSOLVER420c tool.

For TM polarized light, it can be concluded (from FIGS. 28 and 29) that, as already observed before, the transmission (curve 41) and reflection (curve 42) of the slit 11 depends on the thickness of the substrate 10, in the example given the gold substrate 10, in a periodic manner: maximum transmission occurs for a thickness of the substrate 10 of 860 nm, which corresponds with a transmission of 9.7%, and minimum transmission for a thickness of the substrate 10 of 740 nm, which corresponds with a transmission of 3.9%. It has to be noted that, in these calculations, +/−11 diffraction orders are included for TE polarization and +/−51 diffraction orders for TM polarization. For TE polarized light, the transmission decreases with increasing substrate thickness, and the reflection increases up to a certain substrate thickness, after which the reflection is constant.

As an example of a dense array of slits 11, the case is considered of an array with a distance of 0.4 μm between centres of neighbouring slits 11, the slits 11 having a width of 0.2 μm. FIGS. 30 and 31 show the transmission of the periodic array of slits 11 for TM polarized light as a function of the thickness of the substrate 10, in the example given the thickness of the gold layer. Like in the previous example, the transmission varies periodically with the thickness of the gold layer or substrate 10. The envelope of the transmission curve drops exponentially with the thickness of the gold layer, which is due to losses in the gold layer. TM polarized light has a penetration ((1/e)̂2 transmission) depth of ˜62 μm, which is significantly larger than the penetration depth for TE polarized light which is approximately 150 nm. FIG. 32 shows the transmission of the periodic array of slits 11 for TE polarized light as a function of the thickness of the gold layer or substrate 11.

It should be remarked that the present invention is not limited to a periodic array of slits 11 as described above.

From the above discussion and from FIGS. 21 and 22, which show the intensity distribution for a 300 nm thick slit 11 for resp. TE polarized light and TM polarized light, it can be seen that TE polarized light is strongly suppressed and does essentially not reach the exit 15 of the slit 11, while TM polarized light is able to transmit through the slit 11. It has to be noted that a small fraction of the TE polarized light still reaches the exit 15 of the slit 11, as is shown by the simulations. Because the TE polarized light inside the slit 11 decays exponentially, the fraction behind the slit 11 decreases with increasing depth of the slit 11. The decay constant of the TE polarized light increase with decreasing width of the slit 11.

In FIG. 33 the basic idea of a third embodiment of a sensor according to the present invention is described. A sensor according to the third embodiment comprises a substrate 10 with at least one slit 11, with at least one luminophore 25, e.g. fluorophore, in the slit 11. In this embodiment, TE polarized excitation light 44 is used to excite a luminophore 25, e.g. fluorophore, which is present inside the slit 11 in the substrate 10 which may be made of non-transparent material, i.e. of a material that is not transparent for the excitation radiation. Because the excitation light 44 has TE polarization, it will not transmit through the slit 11 and will only excite the luminophore 25, e.g. fluorophore, with an evanescent field.

After excitation, the luminophore 25, e.g. fluorophore, emits unpolarised luminescence radiation 45 that comprises both TE and TM polarization. If the slit 11 is deep, i.e. if the slit 11 has a depth which may typically be larger than twice the decay length, practically only TM polarized luminescence radiation 46 will be able to exit the slit 11 (this is about 50% of the emitted fluorescence radiation). The TE polarized luminescent light is strongly suppressed. For a slit 11 with a depth of twice the decay length, TE polarized radiation emitted by a fluorophore 25 in the center of the slit 11 is attenuated: intensity at the bottom of the slit 11 is only 13% of the intensity at the center of the fluorophore 25.

This third embodiment has both advantages and disadvantages with respect to the first and second embodiment of this invention.

An advantage is that it is easier to collect the emitted luminescence, e.g. fluorescence. If the slit 11 is deep, this means that about 50% of the luminescence, e.g. fluorescence, is able to exit the slit 11, while a hole or gap or other aperture 11 of equal depth would not allow the luminescence, e.g. fluorescence, to exit. This can give extra luminescence, e.g. fluorescence, that is measured, hence yielding a better signal-to-background ratio.

Another advantage is that the number of excited luminophores 25, e.g. fluorophores, in a slit 11 may be much higher, because in the direction of the slits 11 the structure is essentially open, and therefore more emission of fluorescent light may be expected.

A disadvantage of the third embodiment is that from the emitted luminescence, e.g. fluorescence, only 50% is TM polarized, and from this TM luminescence, e.g. fluorescence, only 50% is pointed towards the exit of the slit 11 and the other 50% goes back towards the origin of the excitation beam. This means that only 25% of the emitted luminescence, e.g. fluorescence, is eventually detected. This means that a lower power is detected for a same amount of luminophores 25 present. Therefore, this disadvantage has to be weighed against the effect of advantage of an easier collection in order to determine whether, for specific applications, either apertures, e.g. holes, or slits 11 are required. This depends at least on the depth of the apertures or slits 11.

Similar to the first and second embodiment, the third embodiment also allows extra luminescence, e.g. fluorescence, to be collected for a given numerical aperture of the optics and acceptance angle of the detector 30, by using slanted walls 24 that redirect the radiation, and thus concentrate the radiation into a smaller spatial angle of the slit 11.

TM polarized background luminescence, e.g. fluorescence, that was generated on the excitation side of the slit 11 is able to transmit through the slit 11 and will contribute to the background signal. This leads to an increased background signal, unless steps are taken to suppress this background luminescence, e.g. fluorescence. This can be done by focusing the excitation beam onto the slit 11. Alternatively, as in the prior art, a wash step can be done to reduce the amount of background luminescence, by washing away unbound luminophores 25. Both these options make the third embodiment more complex compared to the first and second embodiment, where this was not necessary.

All embodiments of the present invention show a very small excitation volume. However, in the first and second embodiment this is done in three dimensions, whereas in the current embodiment this is only done in two dimensions. Nevertheless, the third embodiment allows to use deep slits 11 having the advantage that the excitation surface (or volume) can be significantly larger than for the configurations in the first and second embodiment.

Depending on the kind of application the sensor, e.g. biosensor or chemical sensor, has to be used for, advantages and disadvantages have to be considered in order to determine which of the embodiments described hereinabove is best suited for performing a specific application.

The illumination or excitation of the luminophores 25, e.g. fluorophores, in the above described embodiments may be performed more efficiently by using multi-spot light beams focussed onto the apertures or slits 11. Furthermore, the above described embodiments may work with different wavelengths at the same time. To use a different wavelength, only the excitation frequency or wavelength needs to be changed if the hole size is small enough, i.e. if the smallest dimensions of the apertures, e.g. holes or slits 11 stay below the wavelength of the excitation radiation, e.g. below 50% of the wavelength, preferably below 40% of the wavelength of the excitation radiation or if the smallest dimension of the apertures or slits 11 is below the diffraction limit of the medium the aperture or slit 11 is filled with. For example, when the apertures or slits 11 are filled with water having a refractive index of 1.3, this implies that for a wavelength of 700 nm in vacuum the diffraction limit is 269 nm (i.e. wavelength in vacuum/2*index of water). In other embodiments according to the invention, fluorescent nano-particles (quantum dots) may be used with sizes ranging from 1 to 10 nm. Typically an excitation wavelength between 200 and 400 nm will then result in multicolour emission, the emission wavelength being dependent on the particle diameter.

In still further embodiments, electrochemical or chemiluminescent labels may be used. In this case, excitation may be performed electrochemically or chemically.

All the above-described embodiments propose sensors, in particular biosensors, with 3D (array of apertures 11, e.g. holes) or 2 D (array of slits 11) excitation volumes operating inside a fluid such as e.g. water or air. In these embodiments, the fluid channel may comprise a membrane which may, for example, be a thin metal membrane. However, a structure comprising a thin membrane is relatively fragile. This can be overcome by ‘sandwiching’ the array of slits or apertures 11 or the porous substrate 10 between a first or upper slab 47 and a second or lower slab 48 (see further) The first and second slab 47, 48 may preferably be made of a transparent material. Furthermore, for a deep slit or aperture 11, i.e. for slits or apertures 11 with a depth of a few, e.g. ≧3, decay lengths, and for detecting the luminescence, e.g. fluorescence, behind or in front of the slit or aperture 11, the generated luminescence, e.g. fluorescence, is suppressed when propagating through the first or second slab 47, 48, resulting in a significantly lower fluorescent signal than behind or in front of the slit or aperture 11. For example, in the case of an aperture or slit depth of 3 decay lengths, a suppression to 0.002 of the initial intensity may be obtained. A solution for this is to detect the luminescence, e.g. fluorescence, through the upper and/or lower slab 47, 48, resulting in a luminescence, e.g. fluorescence, signal behind the slabs 47, 48 that is significantly larger than the luminescence, e.g. fluorescence, signal behind or in front of the slits or apertures 11.

In a fourth embodiment according to this invention, nano-fluidic channels and a method for forming such nano-fluidic channels is provided. FIG. 34 shows a cross-section of an array of nano-fluidic channels. According to this example, the channel length is uniform in the y-direction. The nano-fluidic channels may comprise a porous substrate 10 having slits or apertures 11 which are sandwiched between a first or upper slab 42 and a second or lower slab 43. The upper and lower slab may preferably be formed out of transparent material. The substrate 10 may be a semiconductor, e.g. Si, or a metal, e.g. gold, substrate, provided that it is not transparent for the excitation radiation. Fluid, e.g. water, may be present in the slits 11.

Next, a method for the fabrication of such a nano-fluidic channel will be discussed. In a first step, substrate material 10 may be deposited onto the first or upper slab 47 (or onto the second or lower slab 48). Then, the substrate material 10 is patterned for forming an array of apertures or slits 11 on top of the slab 47 or 48. Patterning of the substrate material 10 may be done by means of techniques known by persons skilled in the art, such as, for example, microlithography. In a next step, the second or lower slab 48 (or the first or upper slab 47) may be bonded or glued on top of the array of slits or apertures 11. In case of gluing, the glue may penetrate into the nano-channels. This should be prevented. Therefore, the glue that is used is preferably chosen on the basis of transparency, wetting and viscosity.

Excitation of luminophores 25, e.g. fluorophores, which are dissolved in the fluid that is present in the slits or apertures 11 may be done through the upper slab 47 or through the lower slab 48. FIG. 35 illustrates excitation of luminophores 25, e.g. fluorophores, dissolved in the fluid in the slits or apertures 11 through the upper slab 47. This example is not limiting for the invention, excitation may also occur through the lower slab 48. In FIG. 35 reference number 49 indicates the excitation light that may be sent through the upper slab 47. The excitation radiation 49 may be TM or TE polarized. In case the excitation radiation 49 is TM polarized, no evanescent field is generated and the excitation radiation 49 propagates through the slit 11 into the lower slab 48. If the excitation radiation 49 is TE polarized, an evanescent field may be generated and the excitation radiation 49 does essentially not propagate through the slit 11 provided that the slit 11 is sufficiently deep, i.e. has a depth of a few decay lengths, for example 3 decay lengths. The generated luminescence 50, 51, e.g. fluorescence, may then be detected through the upper slab 47 (indicated by arrows 50) and through the lower slab 48 (indicated by arrows 51). The luminescence radiation 50, 51, e.g. luminescence radiation, may mainly be TM polarized.

The slabs 47, 48 may be made such that luminescence radiation 50, 51, e.g. fluorescence radiation, is better collimated and a higher fraction (larger angle view) may reach the detector (not shown). To achieve this, the slabs 47, 48 may each be patterned as indicated in FIG. 36. The patterning may be such that it results in a slab 47, 48 with slanted side walls 52, which enables to collect the luminescence radiation 50, 51 into a smaller, solid angle.

In case of using slits 11 and an evanescent excitation volume, TE polarized excitation light is preferred over TM polarized light, because of its significantly smaller penetration depth into the slits 11. In case of a pinhole 11 with a circular shape on the other hand, TE polarization is equivalent to TM polarization. Therefore, in other embodiments, with a sufficiently low penetration depth, the excitation light may be separated from the luminescence light, e.g. fluorescence light, by exciting through one slab 47, 48, and detecting luminescence, e.g. fluorescence, through the other slab 48, 47.

A possible disadvantage of the fourth embodiment is that the excitation and luminescence light paths, e.g. fluorescence light paths, are in the same direction. With a long penetration depth, this means that excitation radiation 49 and luminescence radiation 50, 51, e.g. fluorescence radiation, will not be separated by the slits or apertures 11, as can be seen from FIG. 35. This may, in a further embodiment, be avoided by excitation in a direction parallel to the slabs 47, 48 (i.e., the y-direction). Therefore, spots 53, which may be directed in a direction substantially parallel, i.e. along the y-direction, to the slabs 47, 48, may be provided in the slits or apertures 11. This is illustrated in FIG. 37. The spots 53 may also be a plane wave that propagates in the y-direction. Preferably, the amount of excitation light going through the upper and lower slabs 47, 48 is minimised. The idea of this embodiment is to use excitation radiation 49 directed in a direction e.g. normal to the plane of the paper when the slits or apertures 11 are assumed to e.g. extend into the paper. In this way it is possible to separate the excitation radiation 49 (not shown in FIG. 37) from the luminescence radiation 50, 51, e.g. fluorescence radiation.

The fourth and fifth embodiment thus show that the slit or aperture structures 11 as described in the first and second embodiment may be used for making nano-fluidic channels with improved mechanical strength and excitation of the luminescence, e.g. fluorescence. Furthermore, the method for making the nano-fluidic channels according to this invention is cheap and simple.

In embodiments according to the invention the selectivity of the sensor, for example biosensor or chemical sensor, may be improved by using surface immobilized ligands that can recognize one or more targets of interest, also called the analyte. In the case where more than one analyte has to be detected, the sensor may comprise an array of different ligands. Examples of suitable ligands may be proteins, antibodies, aptamers, peptides, oligonucleotides, sugars, lectins, etc. The ligands may be immobilized to the inner surface walls (indicated by reference number 58 in FIG. 19) of the aperture(s) or slit(s) 11 e.g. via suitable surface chemistry. The choice of surface chemistry depends merely on the chemical composition of the inner surface walls 58.

For example, when the apertures or slits 11 are formed in a metal such as, for example, gold, silver, Cu or Al, self-assembled monomers can be deposited on the inner surface walls 58, for example using reactants that comprise a first reactive group, such as e.g. a sulfurhydryl group and/or a carboxylic group, which is suitable for binding to the inner surface walls 58 of an aperture or a slit 11. The reactant should furthermore comprise a secondary reactive group that can be used for immobilizing the ligand. For example, the secondary reactive group may be a carboxylic group that can be chemically activated to bind to primary amine groups of the ligand in aqueous solutions. Other immobilizing strategies to various different chemical surfaces are known in the art.

In embodiments of the invention the solution comprising the analyte can be pressed through the apertures or slits 11 in order to facilitate binding of the analyte(s) to the ligand(s), e.g. by pumping. This pumping may be repeated several times. Alternatively a lateral flow can be used in which part of the fluid is going through the apertures or slits 11.

It is to be understood that although preferred embodiments, specific constructions and configurations, as well as materials, have been discussed herein for sensor systems according to the present invention, various changes or modifications in form and detail may be made without departing from the scope and spirit of this invention. For example, the invention may also be applied with methods that do not use optical excitation but, for example, electric excitation. In that case, the methods do not benefit from the advantage of a small excitation volume, but still benefit from the separation between luminescence generated in front of the sensor and the radiation generated inside or behind the sensor. Furthermore, the invention also applies for non-evanescent excitation. In that case, there is still the advantage of a small excitation volume (e.g. for a hole the sensing volume in the plane of the hole is still limited by the dimensions of the hole). Moreover, the fact that the structure is still relatively closed (only open where there are apertures 11 and hence typically at least 50% of the structure may be closed), still results in ‘some’ separation between luminescence generated before the biosensor and luminescence generated elsewhere.

1-21. (canceled)

22. A luminescence sensor comprising:
a region for containing a medium (12) which comprises a plurality of luminescent particles,
a sensor,
an excitation radiation source for producing an excitation radiation (26) and a detector being located respectively at opposite sides of the sensor for detecting luminescence radiation that may be generated by at least one of the luminescent particles,
the sensor comprising a substrate (10), having at least one aperture or slit (11) which is in communication with said region so that at least one luminescent particle of the medium can enter in said aperture or slit, and which has a smallest dimension below the diffraction limit in the medium for producing, when illuminated by said excitation radiation, an evanescent excitation volume which is able to excite in the aperture or slit (11) the at least one luminescent particles which has entered.

23. A luminescence sensor system according to claim 22, wherein the smallest dimension of the at least one aperture or slit (11) is smaller than 50% of the wavelength of the excitation radiation in the medium that fills the at least one aperture or slit (11), preferably smaller than 40% of the wavelength of the excitation radiation in the medium that fills the at least one aperture or slit (11).

24. A luminescence sensor system according to claim 22, wherein the medium comprises water.

25. A luminescence sensor system according to claim 22, wherein the substrate (10) comprises at least one hole (11).

26. A luminescence sensor system according to claim 25, wherein the at least one hole (11) has slanted sidewalls (24).

27. A luminescence sensor system according to claim 22, comprising an array of apertures or slits (11).

28. A luminescence sensor system according to claim 27, wherein the array of apertures or slits (11) is a periodic array.

29. A luminescence sensor system according to claim 22, wherein the substrate (10) provided with at least one aperture or slit (11) is positioned onto another substrate (29).

30. A luminescence sensor system according to claim 29, wherein the other substrate (29) is transparent for excitation radiation (26) and/or for luminescent radiation (27).

31. A luminescence sensor system according to claim 22, wherein the substrate (10) provided with at least one aperture or slit (11) is positioned between a first or upper slab (47) and a second or lower slab (48).

32. A luminescence sensor system according to claim 31, wherein the first or upper slab (47) and/or the second or lower slab (48) are patterned.

33. A luminescence sensor system according to claim 22, wherein the detector (30) is a CCD or a CMOS detector.

34. A luminescence sensor system according to claim 22, the at least one aperture or slit (11) comprising inner surface walls (58), wherein ligands are immobilized on the inner surface walls (58) of the at least one aperture or slit (11).

35. A luminescence sensor system according to claim 22, wherein the luminescence sensor system is a luminescence biosensor system.

36. A luminescence sensor system according to claim 35, wherein the luminescence biosensor system is a fluorescence biosensor system.
